(19) United States
(12) Patent Application Publication
(10) Pub. No.: US 2004/0145592 A1
(43) Pub. Date: Jul. 29, 2004

(54) Apparatus and methods for replacing decorative images with text and/or graphical patterns

(76) Inventor: Irving Yitzchak Twersky, Jerusalem (IL)

Correspondence Address: DARBY & DARBY P.C., P. O. BOX 5257, NEW YORK, NY, 10150-5257, US

(21) Appl. No.: 10/250,817

(22) PCT Filed: Jan. 8, 2002
(86) PCT No.: PCT/IL02/00016

(51) Int. Cl. G09G 5/00

(52) U.S. Cl. 345/619

(57) ABSTRACT

A method and apparatus for generating a decorative image including generating a digital image and defining at least one area within the digital image as an area to be filled and digitally filling the area with decorative lettering which at least partly follows at least a portion of the contour of the area.

### FIELD OF THE INVENTION

The present invention relates to apparatus and methods for generating decorative images.

### BACKGROUND OF THE INVENTION

Micrography is the art of creating a hard-painted picture substantially or even solely of text or graphical patterns. Conventionally, micrography is effected entirely by hand, requiring a huge amount of time and a great degree of precision and skill. Recently, micrography has experienced a strong renewal of interest.

U.S. Pat. No. 6,137,498 to Silvers describes digital composition of a mosaic image from a database of source images. Tile regions in a target image are compared with source image portions to determine the best available matching source image by computing red-green and blue channel root-mean square error. Best-matching source images are positioned at the respective tile regions.

The disclosures of all publications mentioned in the specification and of the publications cited therein are hereby incorporated by reference.

### SUMMARY OF THE INVENTION

The present invention seeks to provide improved apparatus and methods for generating decorative images.

The present invention seeks to provide an efficient micrography image production method. According to a preferred embodiment of the present invention, there is provided a micrography image production system which, typically in the course of an interactive session with the user, replaces lines and/or spaces in an image by text and/or graphical patterns.

Preferably, lines in an image can be defined as spaces into which no text is injected. According to this embodiment of the present invention, the user is preferably afforded an opportunity to define line-width.

The system typically segments the image, identifies the image's internal contours, and replace the internal contours and/or spaces defined thereby with an earlier defined text or graphical pattern. The system preferably comprises PC-software or Macintosh-software compatible with known standards of images such as TIFF, BMP and JPG, with known word processors such as Word which may provide the text, and with graphical software such as Paintshop and Colordraw which may provide and/or modify the image.

There is thus provided, in accordance with a preferred embodiment of the present invention, a method for generating a decorative image including generating a digital image and defining at least one area within the digital image as an area to be filled, and digitally filling the area with decorative lettering which at least partly follows at least a portion of the contour of the area.

Also provided, in accordance with another preferred embodiment of the present invention, is a method for generating a decorative image including generating a digital image and defining at least one area within the digital image as an area to be filled having at least first and second subareas which differ in at least one image characteristic, and digitally filling the area with decorative lettering including filling the first subarea with lettering of a first font and filling the second subarea with lettering of a second font differing in at least one font characteristic from the lettering of a first font.

Further in accordance with a preferred embodiment of the present invention, the image characteristic comprises texture.

Still further in accordance with a preferred embodiment of the present invention, the font characteristic comprises letter size.

Additionally in accordance with a preferred embodiment of the present invention, the image characteristic comprises depth of an object perceived to be represented by the digital image, relative to a plane within which the digital image lies.

Also provided, in accordance with another preferred embodiment of the present invention, is a method for generating a decorative image including generating a digital image and defining at least one area within the digital image as an area to be filled, and digitally filling the area with at least one directional sequence of decorative letters, wherein the direction of each directional sequence is defined by the language of the lettering. For example, several sequences of letters may be provided in several different languages such as English, Hebrew and Chinese.

Further in accordance with a preferred embodiment of the present invention, the decorative letters comprise English language letters and the direction of each directional sequence is left to right.

Also provided, in accordance with another preferred embodiment of the present invention, is a method for generating a decorative image including generating a digital photograph and defining at least one area within the digital photograph as an area to be filled, and digitally filling the area with decorative lettering. The digital photograph may for example comprise a scanned-in hard copy photograph.

Further provided, in accordance with still another preferred embodiment of the present invention, is a method for generating a decorative image including generating a digital image and defining at least one area within the digital image as an area to be filled, including segmenting the area into a plurality of segments and selecting at least some of the plurality of segments as areas to be filled, and digitally filling the areas to be filled, with decorative lettering.

Further in accordance with a preferred embodiment of the present invention, the method also includes sequencing the plurality of segments to be filled and fitting a sequential text into the plurality of segments sequentially, in an order defined by the sequencing process.

Additionally provided, in accordance with still another preferred embodiment of the present invention, is a method for generating a decorative image including generating a digital image and defining at least one area within the digital image as an area to be filled, and digitally filling the area with at least one directional sequence of decorative letters including reading a user input defining at least one area-filling parameter at least partly determining how the sequence is distributed in the area.

Also provided, in accordance with another preferred embodiment of the present invention, is a system for generating a decorative image including a graphic user interface allowing a user to define at least one area within a digital image as an area to be filled, and a text filler digitally filling the area with at least one directional sequence of decorative letters.

Further in accordance with a preferred embodiment of the present invention, the system also includes an image reservoir storing a plurality of images, and an image search engine operative to access images within the image reservoir according to user-provided search cues.

Still further in accordance with a preferred embodiment of the present invention, the system also includes a letter sequence reservoir storing a plurality of letter sequences, and an image search engine operative to access letter sequences within the letter sequence reservoir according to user-provided search cues.

Additionally in accordance with a preferred embodiment of the present invention, the letter sequence reservoir comprises a text reservoir storing a plurality of texts which may be in any language such as but not limited to English, Hebrew, or Chinese.

Typically, the system of the present invention segments the picture into identifiable parts.

Typically the system of the present invention synchronizes the length of the text and the amount of space available to house text.

According to one alternative embodiment of the present invention, a test space is defined by drawing a line which defines a space whose size is approximately 10% of the picture's total space. The text space is filled with the selected text and the amount of text (as a percentage of total text) that fit into the test space is computed. If the text area is too large or too small, the system preferably prompts the user to provide a suitable solution.

Preferably, the system of the present invention is operative to draw lines around the picture text that approximate the contours of the various text regions. The system then inserts text following the general flow of the contour lines drawn.

Optionally, text to region assignment is provided, allowing a user to assign a specific portion of text to a specific image region within the current image. The system typically recomputes text placement to ensure that the selected text falls within its selected region and nonetheless remains in natural readable order vis a vis other texts in other regions or segments. If the system fails to recompute an appropriate text placement the program may leave the selected text in the selected text region even though it is not in natural readable order, or the system may revert to the original text placement computation and place the selected text accordingly, i.e. not within the selected region.

The system of the present invention optionally portrays depth within an image e.g. by manipulating the size and placement of certain text regions.

The system of the present invention optionally represents shading within the image e.g. by manipulating the proximity and level of grayscale of letters.

Optionally, insertion of non-text images is supported. The system may allow a user to insert an additional non-text image into the picture text and then recomputes the area available for text insertion accordingly.

Optionally, the system of the present invention allows a user to use his own handwriting as the text font for the picture text.

Optionally, the system provides a Text length output responsive to a user's selection of an image. the user specifies an image and, optionally, font and spacing parameters, and the system outputs the text length to be used for the picture text.

Preferably, a Contour Formatting feature is provided whereby the system of the present invention manipulates the appearance of text as it meets the contours of the image. For example, text adjacent the image's borders may have a special appearance.

Optionally, the system is operative to manipulate the color of the inserted text to meet the natural colors of the image. This can be accomplished by either changing the color of the text itself or by applying an appropriate background color.

Optionally, libraries of pictures and texts are provided and these can be classified and matched using appropriate searching language. Typically, the picture library and text library are separately searched using respective user-defined keywords. The user may be advised by the system to use the same keywords in searching both libraries in order to select a well matched text and picture.

For example, as shown in FIG. 13, a user may wish to generate a housewarming gift comprising a picture text of a house into which an appropriate text has been incorporated, however the user is not familiar with an appropriate text. The system may comprise a suitable function to search for appropriate text based on content and size of picture.

Optionally, the system can accommodate insertion of more than one language within a picture-text and will maintain the natural readable format for both languages even if the two languages are read in opposite directions, such as English and Hebrew.

Optionally, the system provides Drag and Drop handling of picture objects. For example, a picture object such as a leaf may be dragged and dropped into a picture of a flower and the system then recomputes and adjusts the text in order to inject text into the leaf while maintaining the natural readable format. Conversely, a picture object such as a leaf may also preferably be removed from a picture (e.g. of a flower) and the system then recomputes and adjusts the text in order to inject text previously in the leaf elsewhere in the picture, while maintaining the natural readable format.

The word “text” in the present specification and claims refers to any suitable sequence of icons such as a sequence of decorative lettering or a sequence of graphical images.

### BRIEF DESCRIPTION OF THE DRAWINGS

The present invention will be understood and appreciated from the following detailed description, taken in conjunction with the drawings and appendices in which:

FIGS. 1A-1D, taken together, form a simplified flowchart illustration of a preferred method for incorporating text into a decorative image constructed and operative in accordance with a preferred embodiment of the present invention;

FIG. 2A is a simplified pictorial illustration of a decorative image having different textures;

FIG. 2B is a simplified pictorial illustration of text incorporated into the decorative image of FIG. 2A wherein font size is selected to represent texture; FIG. 3 is a simplified pictorial illustration of a micrographic image in which font size represents depth;

FIG. 4 is a simplified pictorial illustration of a micrographic image in which font size represents intensity in that dark areas are represented in small font whereas light areas are represented in large font;

FIG. 5 is a simplified pictorial illustration of a micrographic image in which interword/line spacing represents intensity in that dark areas are represented by closely spaced text whereas light areas are represented by widely spaced text;

FIG. 6 is a simplified pictorial illustration of a segment to be filled with text, showing distribution of lines of text over the segment as determined by the segment filling step 200 of FIGS. 1A-1D;

FIG. 7 is a simplified flowchart illustration of a micrographic image generation method constructed and operative in accordance with another preferred embodiment of the present invention.

FIG. 8A is a simplified pictorial illustration of an image into which text is to be incorporated, showing segmentation of the image and sequentially numbered labelling of each segment;

FIG. 8B is a simplified pictorial illustration of the image of FIG. 8A into which a long text has been incorporated in sections wherein the text sections are sequentially injected into the sequence of segments defined by the sequential labelling of FIG. 8A;

FIGS. 9-12 are simplified pictorial illustrations of images into which text has been incorporated in accordance with one of the micrographic image generation methods shown and described herein; and

FIG. 13 is a simplified flowchart illustration of an example of a work session which may result from operation of the method of FIGS. 1A-1D in accordance with a preferred embodiment of the present invention.

### DETAILED DESCRIPTION OF PREFERRED EMBODIMENTS

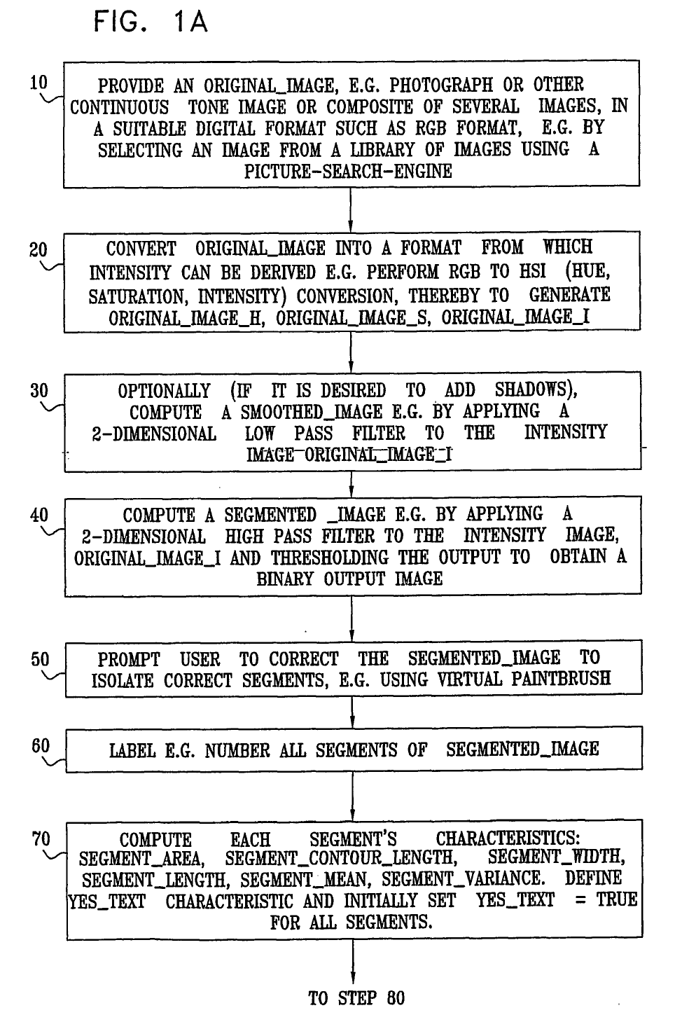

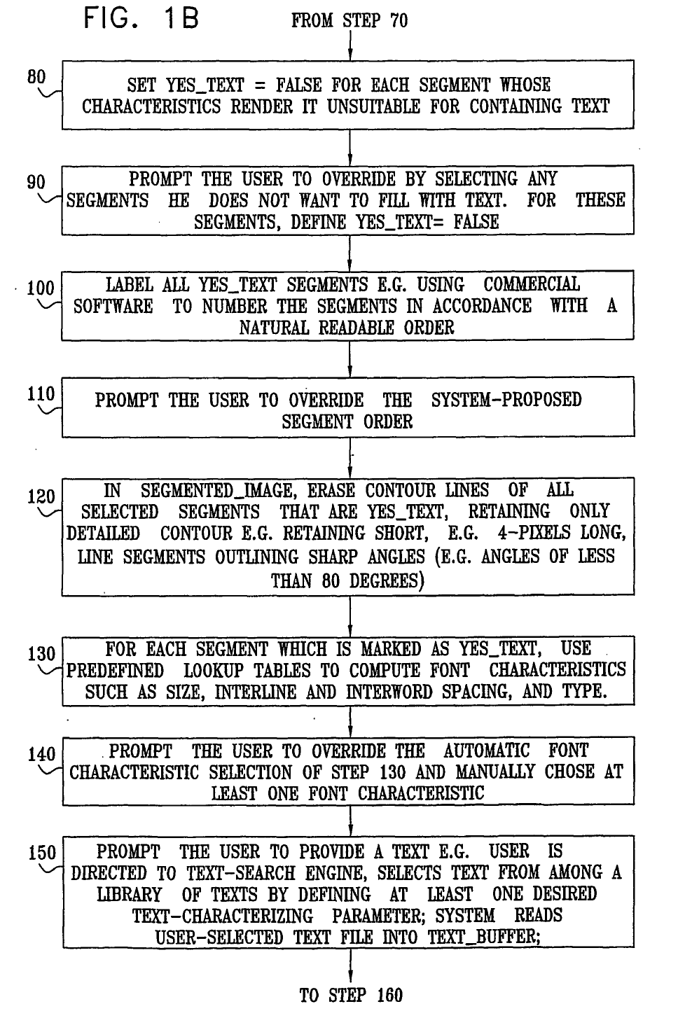

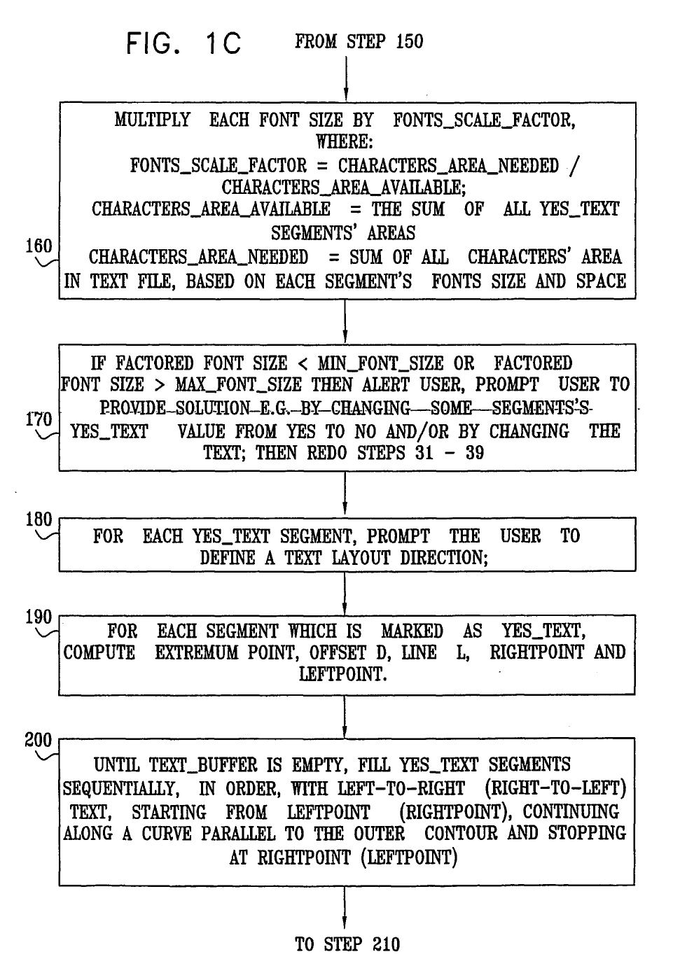

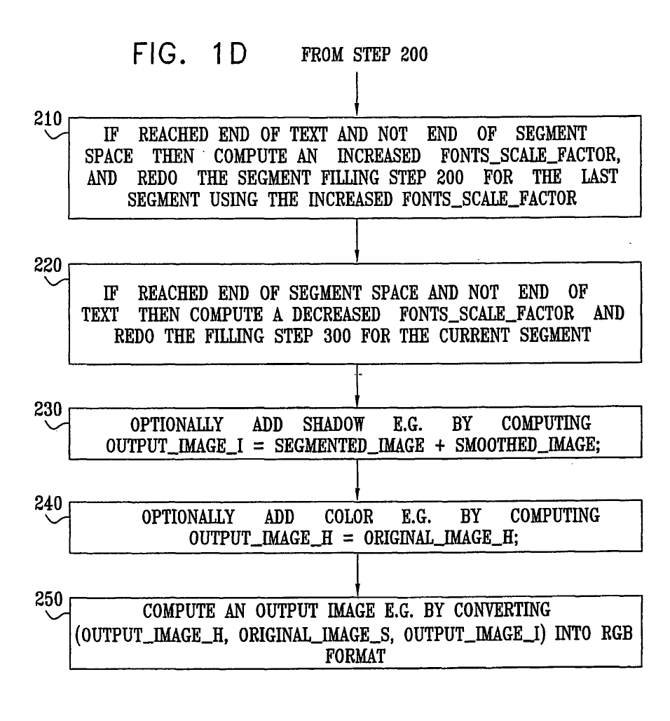

Reference is now made to FIGS. 1A-1D, which, taken together, form a simplified flowchart illustration of a preferred method for incorporating text into a decorative image constructed and operative in accordance with a preferred embodiment of the present invention.

The input to the process typically comprises providing a digital picture e.g. a digital photograph (step 10). The picture may for example be found via a suitable picture search engine operative to search a picture repository in accordance with user-defined cues defining at least one characteristic of a desired picture. The digital photograph or picture includes a plurality of regions differing in at least one of the following characteristics: external contour, internal contour, color, brightness (e.g. mean intensity), texture (gray level variance), 3D-depth. According to a preferred embodiment of the present invention, text is used to represent at least some of the regions, wherein the text has various selectable visual characteristics such as: font type, font boldness, font size, between-letter spacing, between-word spacing, between-line spacing. Preferably, at least one visual text characteristic is used to represent at least one corresponding characteristic of the region in which the text resides.

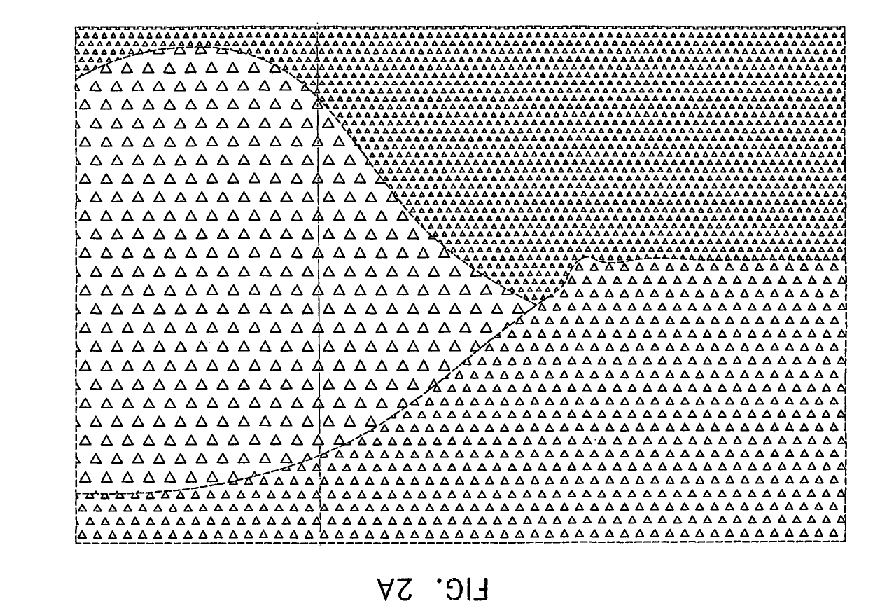

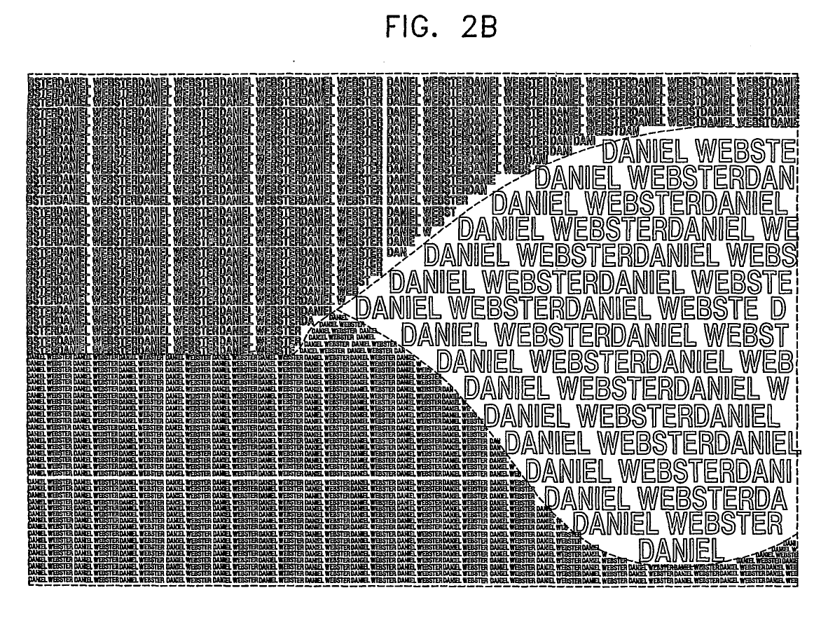

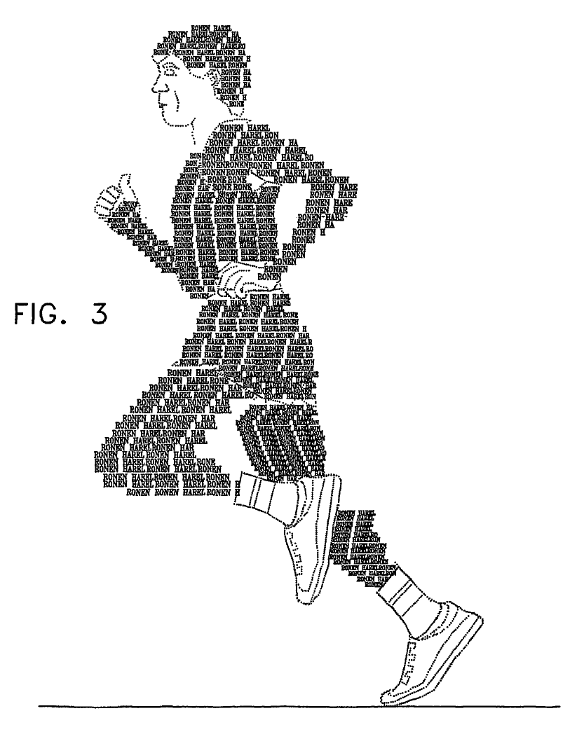

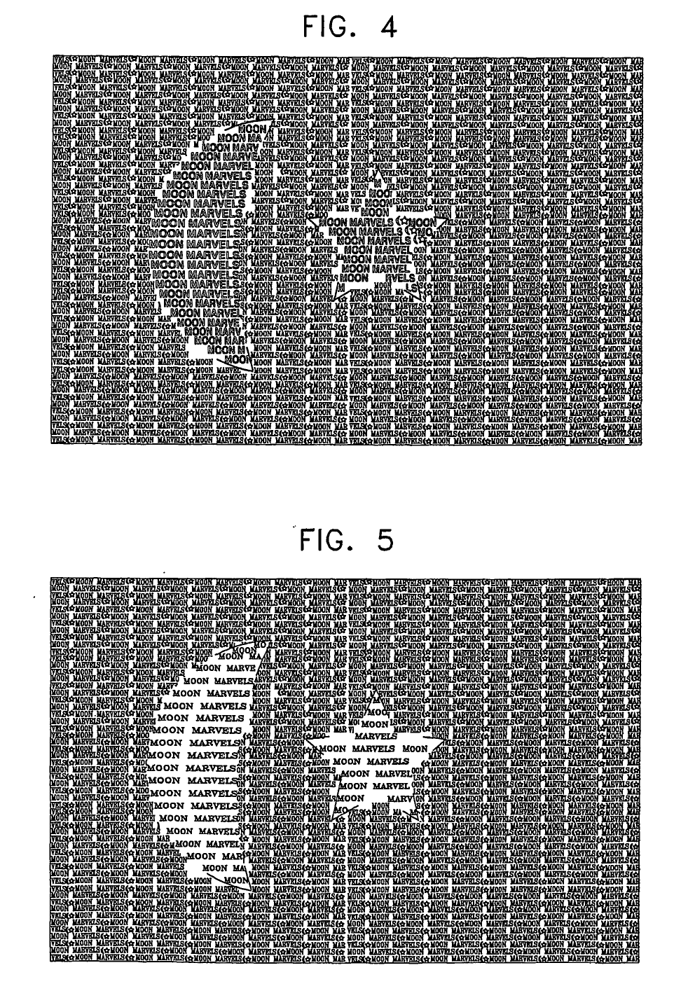

It is appreciated that any suitable correspondence can be built up between visual text characteristics and picture region characteristics. For example, font size may represent texture (large/small letters represent coarse/fine texture) as may be seen by comparing FIGS. 2A and 2B. Font size may also represent depth as shown in FIG. 3 in which large/small letters represent regions close to/far away from the viewpoint. Font size may also represent intensity as shown in FIG. 4, or foreground/background contrast. Boldness of font can be used to represent intensity (dark/light areas represented by bold/fine font). Boldness of font can also or alternatively represent texture (bold/fine font representing rough/fine texture). Type of font can be used to represent color. Spacing between letters, words, lines, or all three of the above may represent intensity (spaced/crowded text representing light/dark areas respectively), as shown in FIG. 5.

It is appreciated that the above correspondences are provided merely by way of example and a software methods automatically incorporating at least one text into a picture in accordance with one, some or all of the above correspondences, or any combinations thereof, or different correspondences, all fall within the scope of a preferred embodiment of the present invention. Preferably, a text incorporation system provided in accordance with a preferred embodiment of the present invention is operative in accordance with a default correspondence; however the interface allows the user to override the correspondence and to define a different correspondence between picture region characteristics and text characteristics utilized to represent them respectively.

According to a preferred embodiment of the present invention, the system is operative to modify the correspondence between picture region characteristics and text characteristics depending on at least one predefined rules relating to picture characteristics. For example, if the texture of an individual picture is found by to be substantially invariant, a text characteristic normally used by the system to represent text may instead be used by the system, for the individual picture in question, to represent some other characteristic of the picture which does vary.

The scanned-in image is typically initially converted into a single-tone image (step 20) such as the I-component image of an HSI (hue, saturation, intensity) image, typically using a conventional colored-picture-to single-tone picture conversation method, such as a conventional RGB to HSI conversion method, e.g. an RGB2HSI function of a conventional image processing product.

Optionally, a smoothed image can be computed (step 30), which can be injected back into the output image (step 230) to create shadow in the image.

Next, the single-tone image is segmentized (step 40) using conventional segmentation methods such as described in Chapter 10, “Segmentation”, in Digital Picture Processing, A. Rosenfeld and A. C. Kak, Academic Press, Inc., Vol. 2. The output of this step is a line drawing in which the area of the picture is partitioned into a plurality of closed regions or segments, each having segment characteristics such as area, contour length, width, segment length, mean intensity, variance of intensity.

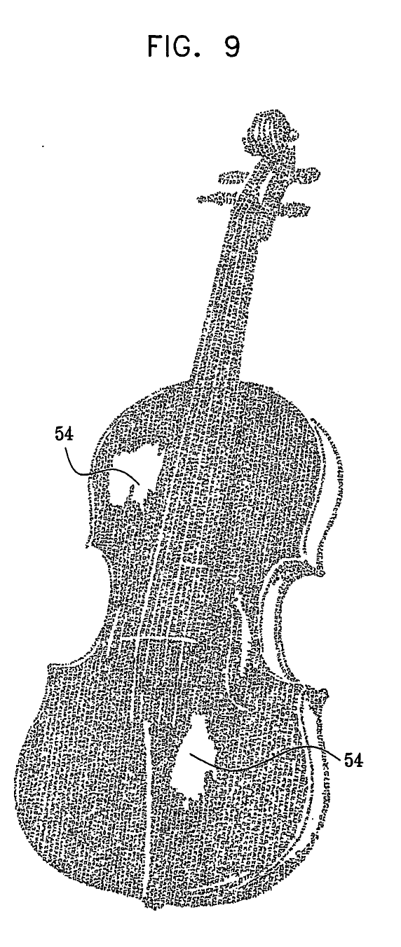

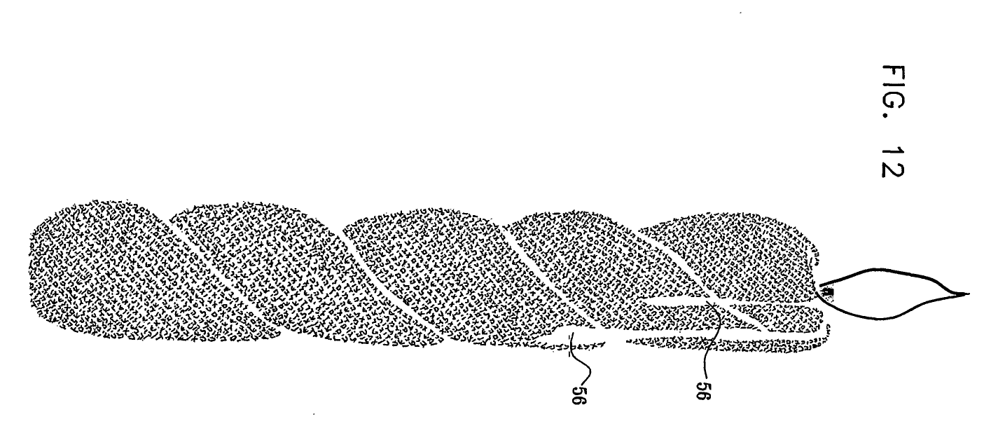

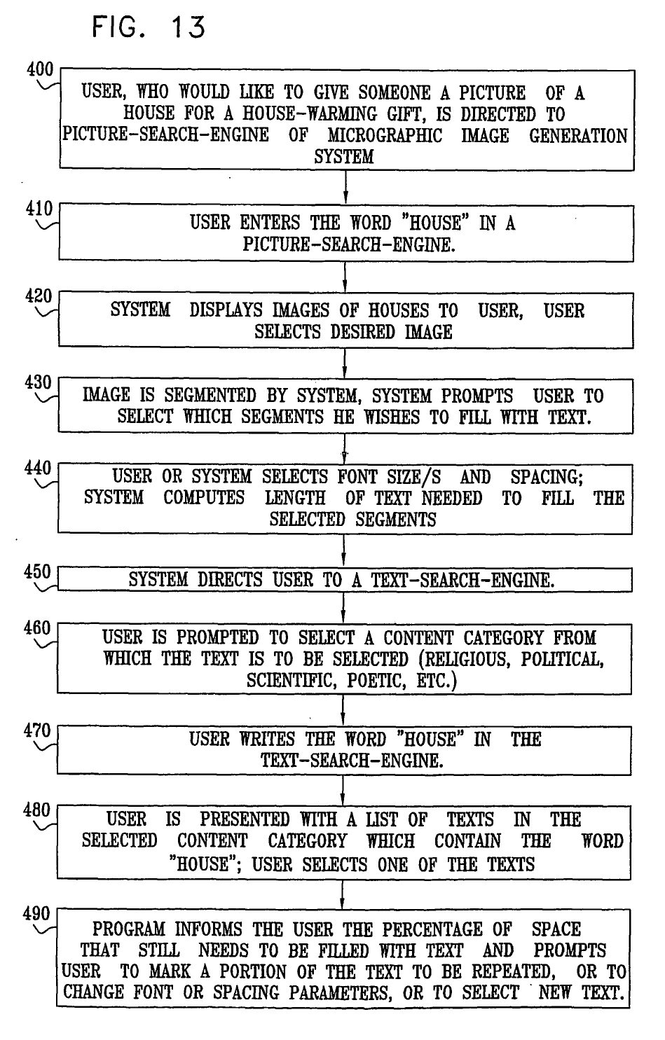

In step 50, the user is prompted to correct the segmented image to create a segment partitioning other than that defined automatically e.g. by using a virtual paintbrush. For example, in FIG. 9, the user may define lightspots 54 if these are not part of the original image and in FIG. 12 the user may define waxdrips 56 if these are not part of the original image, to add interest.

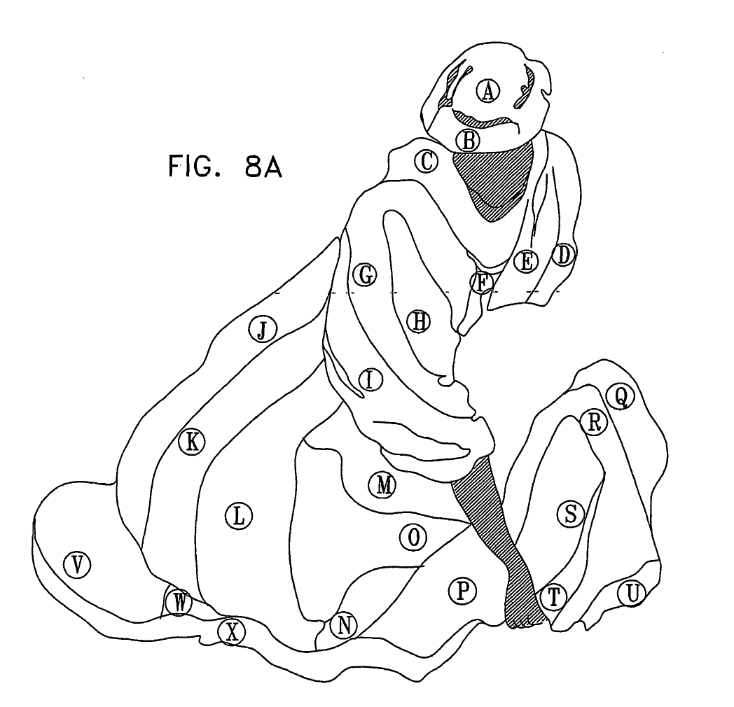

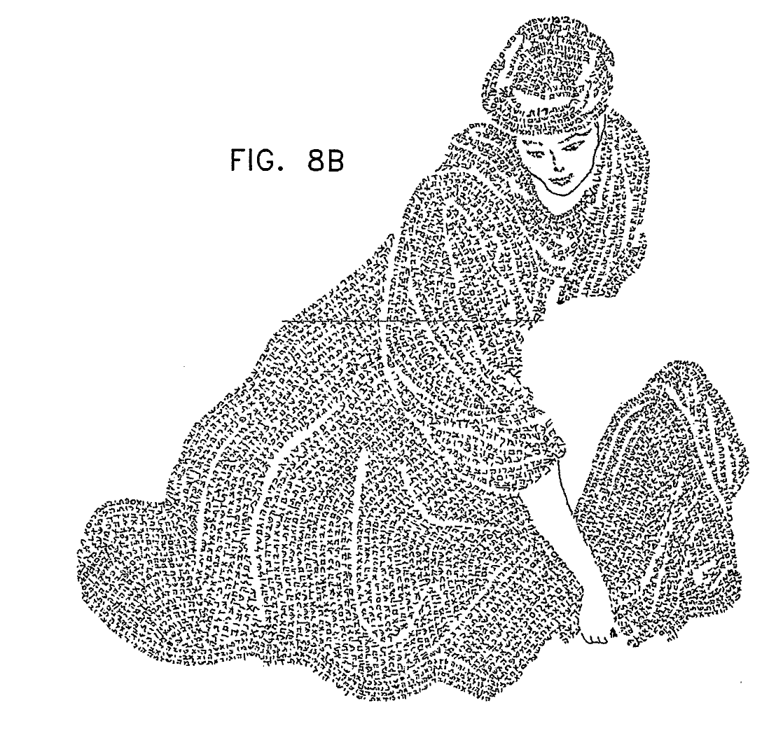

In step 60, all segments of the segmented image are labelled e.g. as shown in FIG. 8A, to allow each segment to be referred to in a well-defined manner.

In step 70, each segment's characteristics are computed. For example, the following characteristics may be computed: Segment Area, Segment Contour Length, Segment Width, Segment Length, Segment Mean, Segment Variance. Also, a yes_text logical parameter is defined and initially set to true for all segments.

In step 80, yes_text is set to false for each segment whose characteristics render it unsuitable for containing text, e.g. for each segment for which one or more selected ones from among the following criteria, or a logical combination thereof, apply:

(Segment_Area>Max_Segment_Area (area too large)

Segment_Area<Min_Segment_Area (area too small)

Segment_Contour_Length>MaxSegment_Contour_Length (contour too wiggly)

Segment_Width<Min_Segment_Width (too narrow)

Segment_Length<Min_Segment_Length (too short)

Segment_Mean>Max_Segment_Mean (too dark)

Segment_Mean<Min_Segment_Mean (too white)

Segment_Variance>Max_Segment_Variance (too much variation in texture)

Segment_Variance<Min_Segment_Variance (texture completely uniform)

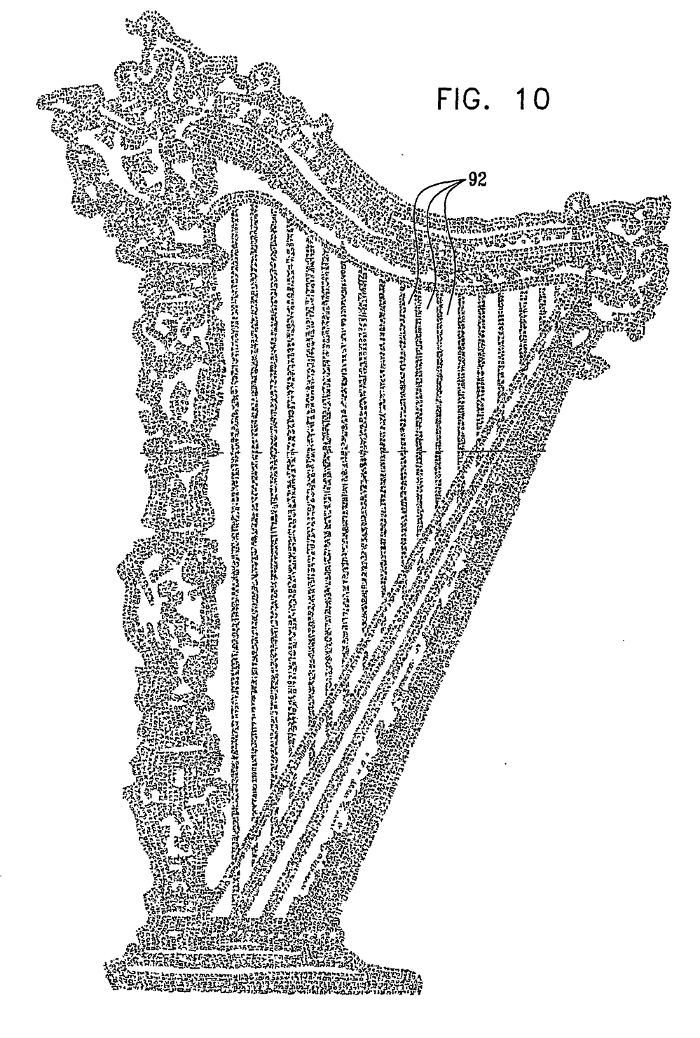

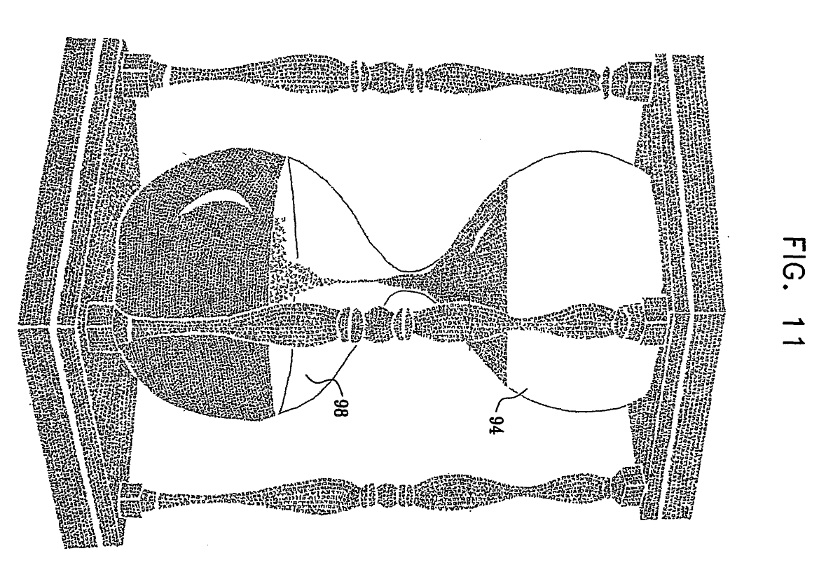

In step 90, the user is prompted to override the decision as to which segments are to be filled with text, and changing Yes_text values accordingly. For example, in FIG. 10, the user has designated the spaces 92 between harpstrings as No_text segments and in FIG. 11, the user has designated the upper, empty portions 94 and 98 of the two hourglass bulbs respectively, as No_text segments.

In step 100, all Yes_Text segments are preferably sequenced e.g. using commercial software to number or letter the segments in accordance with a natural readable order, as shown in FIG. 8A in which a desired sequence is indicated by alphabetical order. In FIG. 8A, No_text segments are indicated by cross-hatching.

In step 110, the user is prompted to override the system-proposed segment order. These steps are useful for applications in which it is desired to use a very long text to represent the image, and the text is to be injected serially, section by section, into more than one segment, typically all segments, in the order defined by steps 100 and 110, as shown in FIG. 8B.

In step 120, contour lines of all selected segments in the segmented image that are Yes_text are erased, typically retaining contour which is too detailed to be represented by text. For example, short, e.g. 4-pixels long, line segments may be retained to outline sharp angles (e.g. angles of less than 80 degrees.

Step 130: For each segment which is marked as Yes_text, font characteristics such as size, interline and interword spacing, and type are preferably determined automatically as a function of segment characteristics, typically using predefined Lookup tables to determine the font characteristics. For example, a lookup table may be generated which outputs Font size as a function of segment area. Another lookup table may output font space and/or font type as a function of segment variance and/or as a function of the color of the segment. More generally, any suitable font characteristic may be employed to visually represent visual segment characteristics as described in detail herein.

In step 140, the user is prompted to override the automatic font characteristic selection of step 130 and manually choose at least one Font characteristic.

It is appreciated that any and all font characteristics may be user-selected rather than being system-determined. One type of font which may be used is handwriting font in which the user typically provides a handwritten reproduction of each letter in the alphabet, thereby to define a font for his own handwriting.

In step 150, the user is prompted to indicate a Text-file and the user-indicated text file is read into a Text buffer. The textfile may comprise a single text in a single language and may be composed of several texts which may even be in several languages respectively. The text may for example be selected from a text repository, using a text search engine operative to search the text repository for texts answering to user-defined text characterizing criteria.

In step 160, each font size is multiplied by Fonts_scale_factor, where:

Fonts_scale_factor=Characters_area_needed/Characters_area_available;

Characters_area_available=the sum of all Yes_Text segments' areas; and

Characters_area_needed=sum of all characters' area in text file, based on each segment's font size and interline/intercharacter spacing.

Step 170: If factored font size<Min _font_size or factored font size>Max_font_size, i.e. if the factored font size is too large or small to be aesthetically pleasing then preferably, the user is alerted and prompted to provide solution e.g. by changing some segments's Yes_text value and/or by changing the text; then redo steps 31-39. This step pertains to applications in which it is desired to exactly fit a long text, section by section, into a sequence of segments.

Step 180: For each Yes_text segment, prompt the user to define a text layout direction.

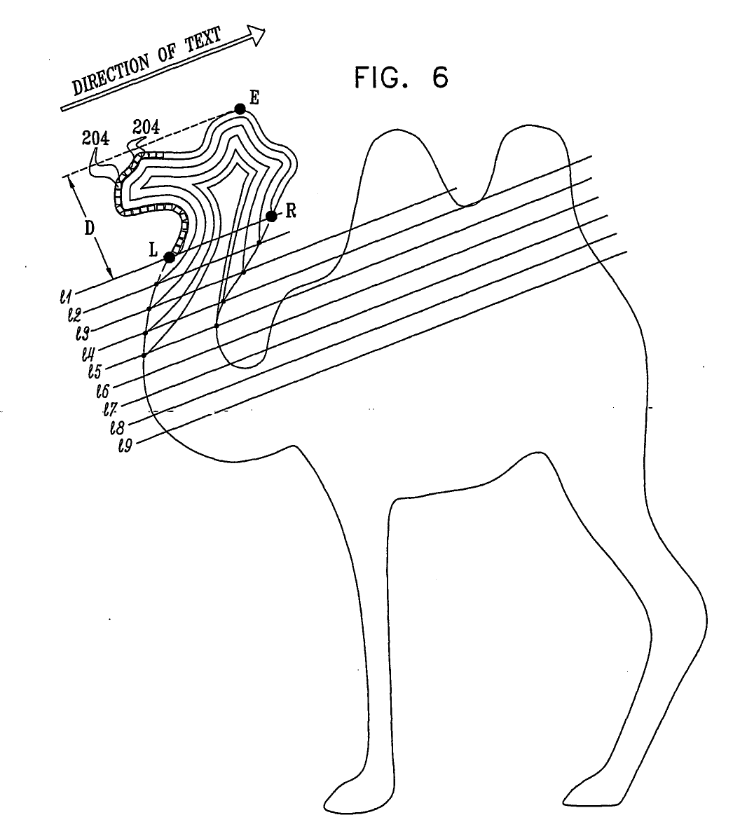

Step 190: For each segment which is marked as Yes_text, compute an extremum point E, an offset D, a sequence of parallel lines 11, 12, 13, . . . separated from one another by as determined by the user-selected or system-selected line spacing parameter, a rightpoint R and a leftpoint L, all as shown in FIG. 6.

These terms are defined as follows:

Extremum_point=a point on the contour of the segment whose tangent is parallel to the requested text layout direction indicated in FIG. 6 by an arrow.

D=user-selected offset from Extremum_point defining extent of curvature of text within the segment. D is typically a multiple of the font size, such as 3*font_size;

l=line, 11, parallel to the requested text layout direction whose offset relative to the extremum point is D;

Rightpoint=point of intersection of L and segment contour, falling to the right of extremum_point; and

leftpoint=point of intersection of L and segment contour, falling to the left of extremum_point.

In step 200, segments are filled. Typically, until the text_buffer is empty, yes_text segments are filled sequentially, in order, with text, starting from leftpoint (rightpoint), continuing along a curve parallel to the outer contour and stopping at rightpoint (leftpoint). The location of each of a sequence of characters (letters) forming a portion of the first line of text is shown in FIG. 6 by a sequence of imaginary boxes 204 each of which may circumscribe a character.

Alternatively, a very short text, such as a person's name, may be provided, and the text is repeated over and over again until all segments in the image are filled.

FIG. 6 is a simplified pictorial illustration of a segment to be filled with text, showing distribution of typically curved lines of text over the segment as computed by the segment filling step 200 of FIGS. 1A-1D.

The filling process depends on the direction of the text's language (left to right for English, right to left for other languages such as Hebrew, up-down for still other languages). If the language direction is left to right then characters may be transferred from the text file to the current segment at the Segmented_Image starting at leftpoint, in parallel to the outer contour, until rightpoint is reached. At this point, l moves away from E, a distance depending on the inter-line spacing determined for that segment, and continues placing characters from leftpoint to right-point, in parallel to the outer contour. The sequential positions of line l are marked in FIG. 6 by 11, 12, . . .

If the language direction is right to left then characters are transferred from the text file, to the current segment at the Segmented_Image starting at Rightpoint, in parallel to the outer contour, till Leftpoint is reached. The system then moves down one line, and continues placing characters from rightpoint to leftpoint, in parallel to the outer contour. This process, or the above left-to-right process, is repeated until the segment is full at which point the system proceeds to the next yes_text=true segment.

Step 210: If the end of text is reached and not all segments are full, then the system may compute an increased Fonts_scale_factor, and redo the segment filling step 200 for the last segment using the increased fonts_scale_factor. If a certain proportion of the total segment area remains empty, the fonts scale factor is typically increased by approximately the same proportion.

Step 220 is the converse occurrence, i.e. all segments are full but the end of the text has not been reached. In this case a decreased Fonts_scale_factor is computed and the filling step 300 is redone for the current segment. If a certain proportion of the total text remains unused, the fonts scale factor is typically decreased by approximately the same proportion.

In step 230, shadow is optionally added e.g. by computing Output_Image_I=Segmented_Image+Smoothed_Image.

In step 240, color is optionally added e.g. by computing Output_Image_H=Original_Image_H. It is appreciated that color can be injected by printing colored letters and/or by printing letters that may not be colored, on a suitably colored background.

In step 260, an output image is generated e.g. by converting (output_image_H, original_image_S, output_image_I) into RGB format.

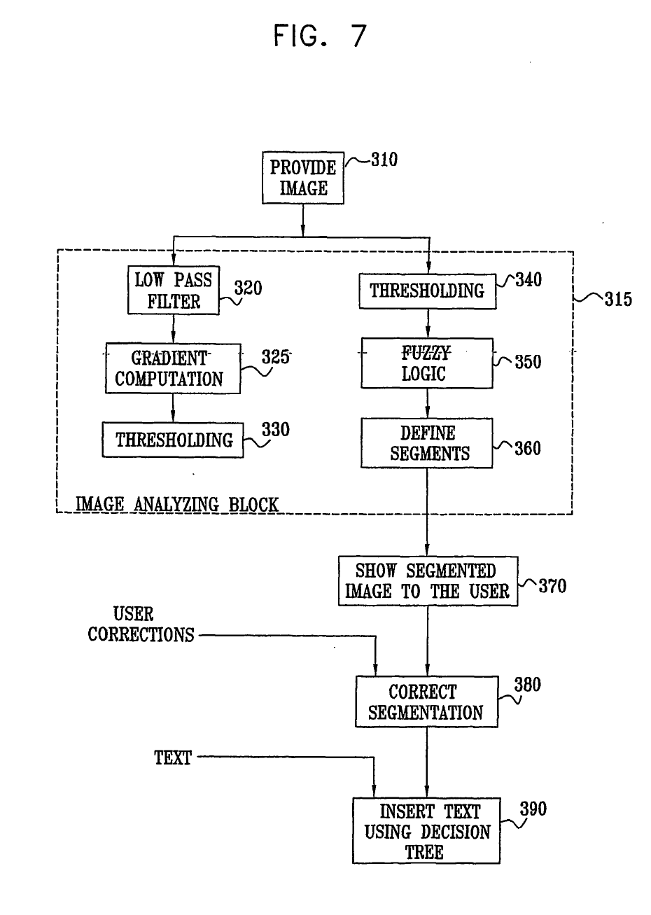

Reference is now made to FIG. 7 which is a simplified flowchart illustration of a micrographic image generation method constructed and operative in accordance with another preferred embodiment of the present invention. Initially (step 310), the user provides an image into which lettering is to be embedded. Typically, a suitable user interface prompts the user to insert a picture as an input to the process. This can be done e.g. by revealing to the system the system the name and location of a digitized picture e.g. a digital photograph, or by scanning a hard copy image into the computer. Once an image has been received by the system, an image analyzing process 315 begins.

Typically, the image analyzing process begins with distinguishing between the various objects in the picture. The system splits the image into segments, each segment possessing some property distinct from its neighbor such as color and/or intensity. Suitable segmentation techniques include Thresholding (step 340) and Edge Finding. Thresholding is an area operation whose output is the set of pixels that generally belong to the objects in an image. Alternatively, in edge finding, the output typically comprises only those pixels that belong to the borders of the objects.

Thresholding segmentation typically uses an adaptive threshold value, based on the content of the picture. Edge Finding typically uses a Gradient-based procedure in order to find the closed contours around the objects. This is typically accomplished by using a low pass filter (step 320), gradient computation (step 325) and then operating a suitable threshold (step 330). The low pass operation 320 is useful for reduction of noise that is generated by the edge detection operation.

Since no segmentation technique is perfect, a decision system is typically provided based on a Fuzzy Logic process (step 350) to combine the results of those two techniques. Fuzzy Logic is a departure from classical two-valued sets and logic, that uses “soft” linguistic (e.g. large, hot, tall) system variables and a continuous range of truth values in the interval [0,1], rather than strict binary (True or False) decisions and assignments.

At the end of this step, the segmented image is displayed to the user (step 370). Manual corrections can be made to the image (step 380) in order to improve the segmentation results.

Now, the user is asked by the system to identify the name and location of the text file he wishes to insert (step 390) into the picture. The user may also be asked by a pop-up menu to select an intuitive description of the scene's nature (romantic, violence, bible etc.).

The user's answers, the file size and the amount of details in the image serves as inputs to a Decision Tree. The outputs are decisions regarding the font shape and size, the location where to fill the text in and the spaces needed. A copy of the original image is then produced, where text or geographical patterns replace lines and segmented spaces.

Optionally, the picture is shown to the user for his comments and further corrections. The user can decide to remove text from some areas leaving them open and clear, or to insert text into some other, left open areas. The user can decide whether or not to replace a line of text, with a straight line, or if he wishes, change the font size and shape.

Optionally, the system of the present invention has a drag-and-drop feature allowing a user to drag and a drop a picture object, such as a leaf in a picture of a flower. The system typically asks the user if he wishes the flower to be remade of text, or left in its original pictorial form. The system then recomputes and adjusts the existing text as necessary in order to maintain the natural readable format.

Preferably, the system recommends a sequencing of segments which fosters readability. The system also preferably lays text, within each segment, in a manner which fosters readability, for example, not allowing the top of the letters to tilt beyond a certain angle.

Preferably, lines in an image can be defined as spaces into which no text is injected. This is shown in FIG. 8B in which no text is injected into the creases of the woman's dress. According to this embodiment of the present invention, the user is preferably afforded an opportunity to define line-width.

It is appreciated that the methods shown and described in the present invention are useful for a broad variety of applications including but not limited to incorporation of microtext images onto or into any of the following substrates:

Advertisement campaigns, corporate promotional materials; logos; photograph albums; gifts and souvenirs formed from text of religious or national significance; patterns for fabrics and clothing; ceramics, clocks, crystal, cookware, matches, wall paintings, flags and signs; book covers, personalized gifts, greeting cards and stationary; calendars.

The methods shown and described herein may be implemented as plug-in software for suitable computer graphics packages such as Coral Draw, Freehand and Photoshop.

It is appreciated that the software components of the present invention may, if desired, be implemented in ROM (read-only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims that follow:

1. A method for generating a decorative image comprising:
generating a digital image and defining at least one area within the digital image as an area to be filled; and
digitally filling the area with decorative lettering which at least partly follows at least a portion of the contour of the area.

2. A method for generating a decorative image comprising:
generating a digital image and defining at least one area within the digital image as an area to be filled having at least first and second subareas which differ in at least one image characteristic; and
digitally filling the area with decorative lettering including filling the first subarea with lettering of a first font and filling the second subarea with lettering of a second font differing in at least one font characteristic from the lettering of a first font.

3. A method according to claim 2 wherein said image characteristic comprises texture.

4. A method according to claim 2 wherein said font characteristic comprises letter size.

5. A method according to claim 2 wherein said image characteristic comprises depth of an object perceived to be represented by the digital image, relative to a plane within which the digital image lies.

6. A method for generating a decorative image comprising:
generating a digital image and defining at least one area within the digital image as an area to be filled; and
digitally filling the area with at least one directional sequence of decorative letters, wherein the direction of each directional sequence is defined by the language of the lettering.

7. A method according to claim 6 wherein the decorative letters comprise English language letters and the direction of each directional sequence is left to right.

8. A method for generating a decorative image comprising:
generating a digital photograph and defining at least one area within the digital photograph as an area to be filled; and
digitally filling the area with decorative lettering.

9. A method for generating a decorative image comprising:
generating a digital image and defining at least one area within the digital image as an area to be filled, including segmenting said area into a plurality of segments and selecting at least some of the plurality of segments as areas to be filled; and
digitally filling the areas to be filled, with decorative lettering.

10. A method according to claim 9 and also comprising sequencing the plurality of segments to be filled and fitting a sequential text into the plurality of segments sequentially, in an order defined by the sequencing process.

11. A method for generating a decorative image comprising:
generating a digital image and defining at least one area within the digital image as an area to be filled; and
digitally filling the area with at least one directional sequence of decorative letters including reading a user input defining at least one area-filling parameter at least partly determining how the sequence is distributed in the area.

12. A system for generating a decorative image comprising:
a graphic user interface allowing a user to define at least one area within a digital image as an area to be filled; and
a text filler digitally filling the area with at least one directional sequence of decorative letters.

13. A system according to claim 12 and also comprising:
an image reservoir storing a plurality of images; and
an image search engine operative to access images within the image reservoir according to user-provided search cues.

14. A system according to claim 12 and also comprising:
a letter sequence reservoir storing a plurality of letter sequences; and
an image search engine operative to access letter sequences within the letter sequence reservoir according to user-provided search cues.

15. A system according to claim 14 wherein said letter sequence reservoir comprises a text reservoir storing a plurality of texts.

16. A method according to claim 6 wherein said at least one directional sequence comprises a plurality of directional sequences of decorative letters in a corresponding plurality of languages.
